(19) United States
(12) Patent Application Publication
(10) Pub. No.: US 2005/0019529 A1
(43) Pub. Date: Jan. 27, 2005

(54) Method for applying coating to shoe material and shoe material structure formed by this method

(76) Inventor: Wen-Tsung Fang, Taichung (TW)

Correspondence Address: CHARLES E. BAXLEY, ESQ., 90 JOHN STREET, THIRD FLOOR, NEW YORK, NY, 10038, US

(21) Appl. No.: 10/627,369

(22) Filed: Jul. 24, 2003

(51) Int. Cl. B05D 1/04; B32B 5/16

(52) U.S. Cl. 428/143; 427/202; 427/475

(57) ABSTRACT

A method for applying coating to shoe material and includes the steps as follows: (a). selecting a shoe material with adhesive surface; (b). applying adhesive to the adhesive surface of the shoe; (c). putting the shoe material with adhesive in a chamber, the chamber being capable of spraying out coating materials in form of powder particles, through an electrostatic the powder particles being evenly suspended above the shoe; (d). the suspended powder particles falling down and evenly adhering to the adhesive surface of the shoe, whereby the adhesive surface of the shoe material having a special texture of the coating layer. The structure of which includes: a shoe material having a adhesive surface defined thereon; an adhesive layer being on the adhesive surface of the shoe material; a coating layer formed on the surface of the adhesive layer in form of powder particles.

### BACKGROUND OF THE INVENTION

1. Field of the Invention

The present invention relates to a method for applying coating to upper or other part of a shoe material and its structure, and more particularly to a method for enabling the surface of the shoe material to has a texture of cloth without stitching a real cloth thereon.

2. Description of the Prior Arts

Shoes are indispensable consumer goods for consumers, however, the conventional shoes only can be changed in its shapes or colors so as to attract the consumers. And the consumers will lose interests if the shape and color of the shoes are not much changed frequently, in this case, how to find a method capable of applying coating to the surface of a shoe so as to change the texture has become a new good way of attracting the consumers and also the motive of the present invention.

### SUMMARY OF THE INVENTION

In accordance with one aspect of the present invention, there is provided with a method for applying coating to shoe material and includes the steps as follows: (1). material providing step: selecting a shoe material with adhesive surface; (2). gluing step: applying adhesive to the adhesive surface of the shoe; (3). coating materials forming step: putting the shoe material with adhesive in a chamber, the chamber being capable of spraying out coating materials in form of powder particles, through an electrostatic the powder particles being evenly suspended above the shoe; (4). coating layer forming step: the suspended powder particles falling down and evenly adhering to the adhesive surface of the shoe, whereby the adhesive surface of the shoe material having a special texture of the coating layer.

The primary object of the present invention is to provide a method for applying coating to shoe material and its structure, which enables the surface of the shoe material to has a texture of cloth without stitching a real cloth thereon, such that the shoes with coating will be more competitive in market.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is a flow chart of illustrating a method of the present invention for applying coating to shoe material;

FIG. 2 is an illustrative view of the present invention to show a shoe having a clean adhesive surface;

FIG. 3 is an illustrative view of the present invention to show the shoe is applied with adhesive on the adhesive surface thereof;

FIG. 4 is another illustrative view of the present invention to show the shoe being place in a chamber and applied with powder particles on the adhesive surface thereof;

FIG. 5 is a plan view of the present invention of showing the shoe with coating layer;

FIG. 6 is a cross sectional view in accordance with the present invention to illustrate the respective layers of shoes material with coating layer;

FIG. 7 is a perspective view of a shoe applied with coating layer in accordance with the present invention.

### DETAILED DESCRIPTION OF THE PREFERRED EMBODIMENTS

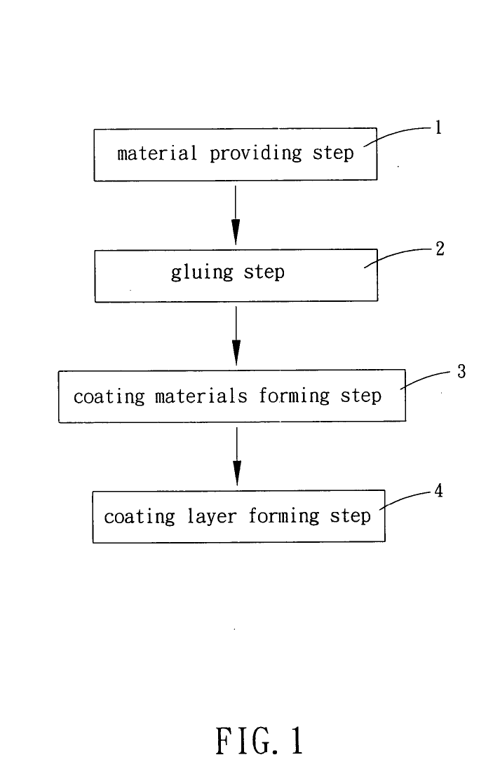

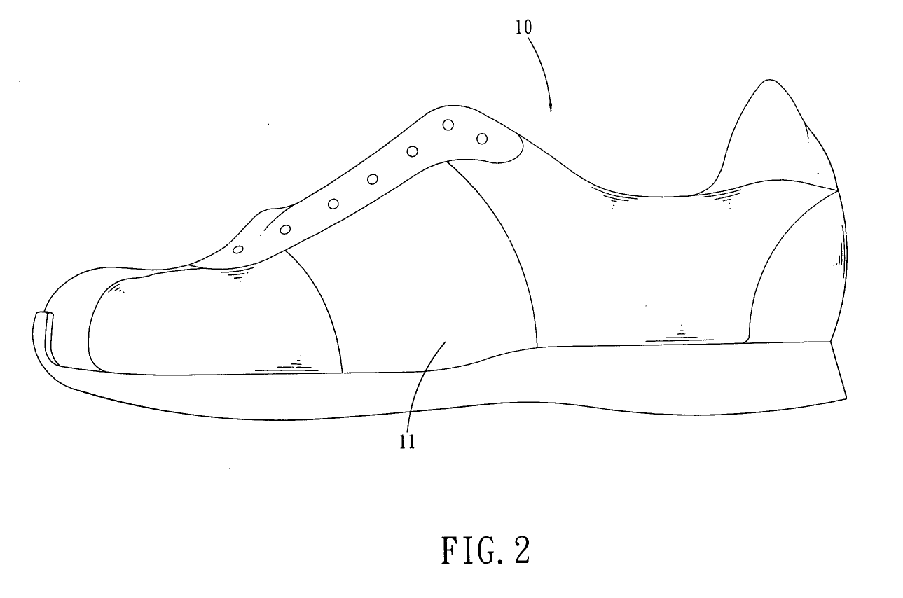

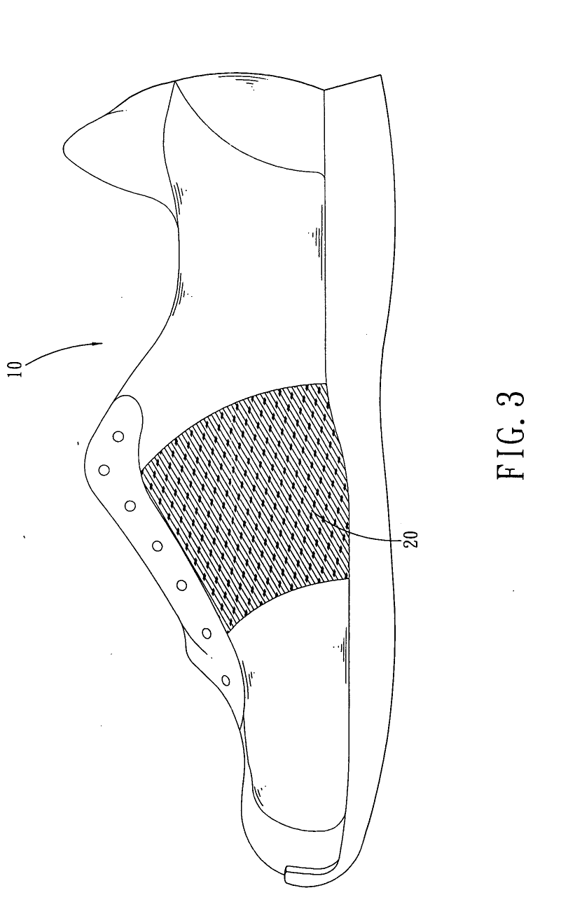

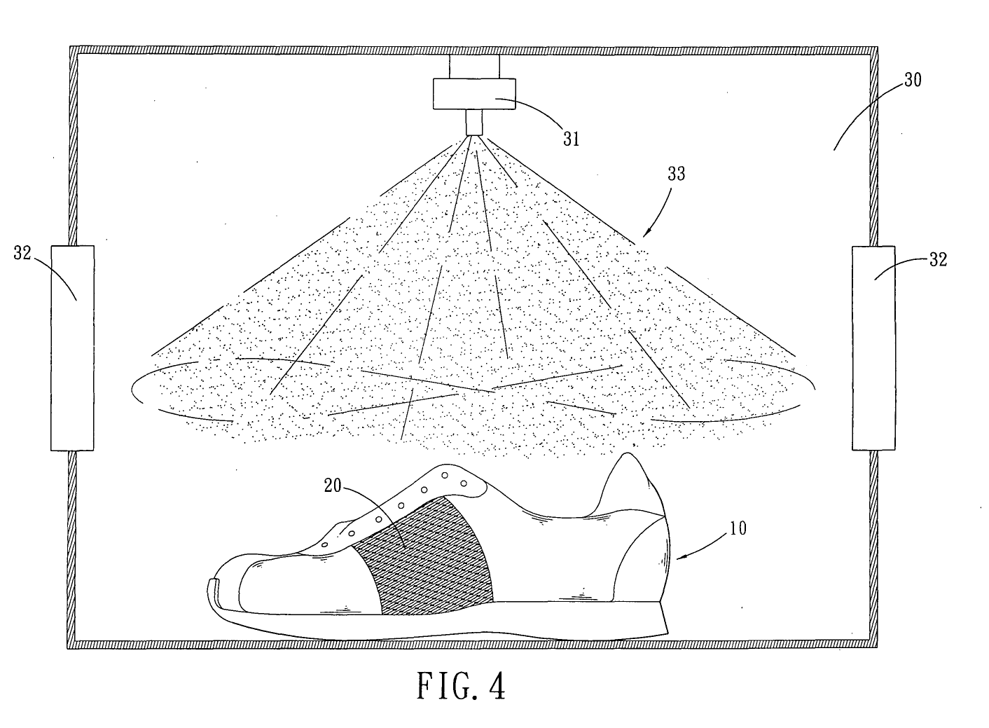

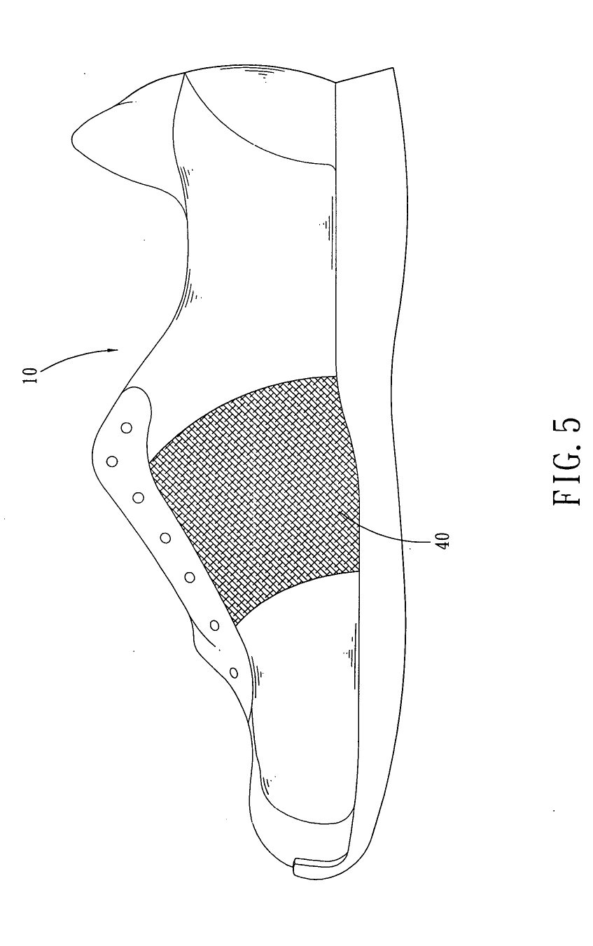

Referring to FIG. 1, wherein a method for applying coating to the upper or other part of a shoe material is illustrated and including the following steps:
(a). material providing step: as shown in FIG. 2, select a shoe material 10 having adhesive surface 11 defined thereof (takes the upper of shoe material as an example), the adhesive surface 11 is formed on the surface of the shoe material 10 and can be formed with patterns according to needs.
(b). gluing step: applying adhesive 20 to the adhesive surface 11 of the shoe material 10 (as shown in FIG. 3) for adhering attachments.
(c). coating materials forming step: putting the shoe material 10 with adhesive in a chamber 30, as shown in FIG. 4, at the top of the chamber 30 is disposed with an atomizing nozzle 31 filled with desired non-adhesive coating materials and at both sides of the same is respectively defined with an electrode plate 32 with a predetermined voltages, so as to generate a magnetic field between the two electrode plates 32 (viz. effecting an electrostatic field therebetween). Through the atomizing nozzle 31 the coating materials is sprayed out in form of powder particles 33. The electrostatic field between the two electrode plates 32 enables the powder particles 33 to be evenly suspended above the shoe material 10 in the chamber 30.
(d). coating layer forming step: the suspended powder particles 33 fall at the surface of the shoe material 10 and evenly adhere to the adhesive layer 20 and formed a coating layer 40. And then takes out the shoe material 10 by clearing the powder particles 33 off the undesired portion of shoe material 10. Such that the adhesive surface 11 of the shoe material 10 will have a special texture of the coating layer 40 (as shown in FIG. 5).

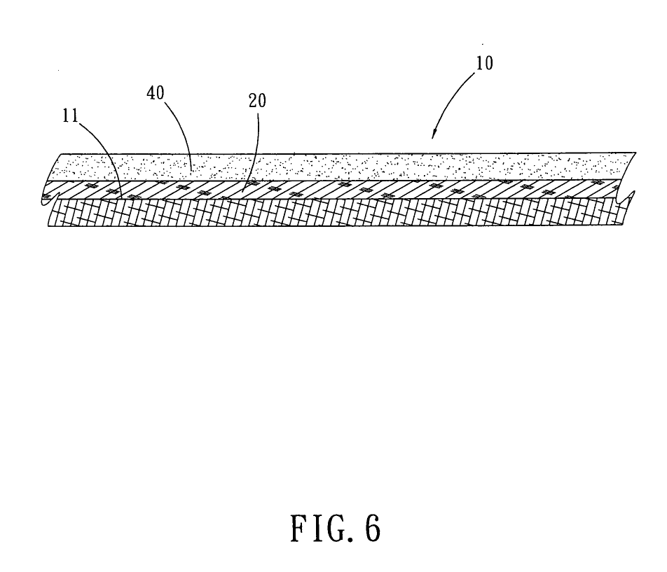

Referring to FIG. 6, wherein the upper of the shoe material 10 includes an essential layer of the shoe material 10, an adhesive layer 20 and a coating layer 40. Wherein:

The shoe material 10 has an adhesive surface 11 with predetermined pattern formed at the surface thereof.

The adhesive layer 20 is formed at the adhesive surface 11 of the shoe material 10.

The coating layer 40 is formed on the surface of the adhesive layer 20 in form of powder particles, such that the adhesive surface 11 of the shoe material 10 has a texture of cloth.

Just as the above description, if the shoe material 10 is formed with predetermined pattern, the shoe will not only have a special texture (the cloth-like texture of the coating layer) but also have a nice appearance with desired pattern.

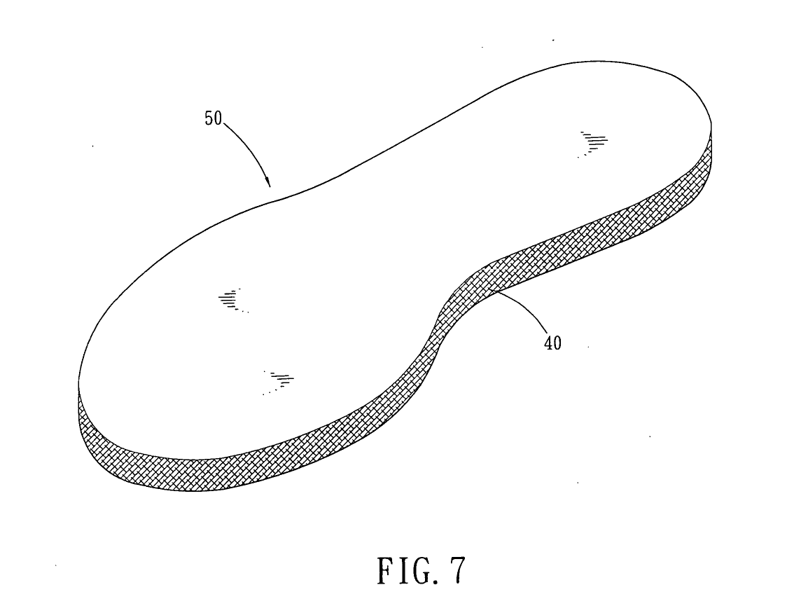

Referring finally to FIG. 7, which shows that the shoe material mentioned in the steps of coat forming can be a sole 50 and which also can be applied with coating layer 40 thereon.

While we have shown and described various embodiments in accordance with the present invention, it should be clear to those skilled in the art that further embodiments may be made without departing from the scope of the present invention.

1. A method for applying coating to the upper or other parts of a shoe material, comprising the step of:
(a). material providing step: selecting a shoe material with adhesive surface;
(b). gluing step: applying adhesive to the adhesive surface of the shoe;
(c). coating materials forming step: putting the shoe material with adhesive in a chamber, the chamber being capable of spraying out coating materials in form of powder particles, through an electrostatic the powder particles being evenly suspended above the shoe;
(d). coating layer forming step: the suspended powder particles falling down and evenly adhering to the adhesive surface of the shoe, whereby the adhesive surface of the shoe material having a special texture of the coating layer.

2. A shoe material coating structure comprising:
a shoe material having a adhesive surface defined thereon;
an adhesive layer being on the adhesive surface of the shoe material;
a coating layer formed on the surface of the adhesive layer in form of powder particles.
